(19) United States
(12) Patent Application Publication
(10) Pub. No.: US 2017/0318123 A1
(43) Pub. Date: Nov. 2, 2017

(54) CROSS-DEVICE AND CROSS-PLATFORM APPLICATION INSTALLATION CATALOG SYSTEM AND METHOD

(71) Applicant: INTERNATIONAL BUSINESS MACHINES CORPORATION, Armonk, NY (US)

(72) Inventors: Dustin K. Amrhein, Zachary, LA (US); Kulvir S. Bhogal, Fort Worth, TX (US); Nitin Gaur, Round Rock, TX (US)

(21) Appl. No.: 15/141,460

(22) Filed: Apr. 28, 2016

(51) Int. Cl. H04L 29/08; G06F 9/445

(52) U.S. Cl. CPC H04L 67/34; G06F 8/61; H04L 67/06

(57) ABSTRACT

To install applications, which were installed on a current device of a first platform, onto a new device of a second platform, an application installation catalog system obtains and stores a list of first apps installed on a current electronic device and a profile of the current electronic device, and initiates downloading and installation of the corresponding apps in the new electronic device.

### BACKGROUND

The present invention relates to the installation of applications on electronic devices and more specifically, to systems and methods for installing applications, which were installed on a first device of a first platform, onto a second device of a second platform.

Electronic devices, both mobile and otherwise, are ever-present. As technology advances, device manufacturers upgrade their products on a regular basis to offer faster speed, more capability, more memory, or even just more bells and whistles. The functionality of these electronic devices comes from the applications (“apps”) that users install. It is not unusual for a user to have installed dozens of apps on, for example, a mobile device, generally purchased and downloaded from an online store, such as the App Store® for iOS devices and Google Play® for Android® devices.

Beneath the level of the application itself and its user interface is an operating system (“OS”) which manages the device's resources on behalf of the application. Different manufacturers have developed different operating systems that will only function on certain devices and are, therefore, “platform-specific.” iOS and Android are two common operating systems for current mobile devices. Applications are similarly platform-specific in that each will only run under particular operating system. Because an application written for one operating system will not run under a different operating system, some developers have written different versions of their applications to run on the devices with different operating systems.

As different devices incorporate new and better functions and features, users often upgrade their devices within the same operating system. Sometimes, too, a device running a different operating system will be so attractive that a user will want to switch. To do so, the user must first determine which of the applications installed on the current device have counterparts capable of running on the new device. Then, each of those applications must be obtained and downloaded from an online store providing applications for the new operating system, sometimes having to pay again for the app. After that, the user must configure and fine-tune the applications' settings to his or her personal preferences. All of which can be a time consuming and tedious process, particularly in an enterprise environment deploying new devices or in which users supply their own devices (BYOD) that may not be of the same platform.

### BRIEF SUMMARY

Processes, machines, and manufactures are provided herein where embodiments may be directed to cross-device and cross platform application installation and cataloguing. This may be include maintaining a profile catalog of installed applications and matching corresponding platform specific applications when operating system platform changes occur.

Embodiments may provide for and promote enterprise level systematic management and automation that serves to remove or reduce the inconvenience of platform specific boundaries and may serve to encourage a seamless and frictionless or otherwise automated cross mobile platform migration between operating systems on the same device or different devices.

Embodiments may be directed to enterprise level application provisioning and syncing system components. Provisioning or syncing or other operations in embodiments may be configured to establish a framework that can support or enable multi-platform application mapping by various techniques. These techniques may include the use of a name, an application ID and or a mobile OS specific application ID. The name may be that of the application, a provider or department, etc. The application ID may be metadata describing the application independent of the Mobile OS, and may be unique to the vendor, department, etc. Mobile OS Specific App ID may be ID specific to a Mobile OS. These names, application IDs and Mobile OS specific App IDs should be preferably searchable for possible match.

An enterprise level computer program product for installing applications, which were installed on a first device of a first platform, onto a second device of a second platform may be provided in embodiments. These embodiments may comprise a computer readable storage medium having program instructions embodied therewith where the program instructions may be readable by a circuit to cause the circuit to perform a method comprising: obtaining and storing a list of first apps installed on a current electronic device and a profile of the current electronic device with the current electronic device running a first operating system. Embodiments may further include receiving an identification of a new electronic device and request for registration of the new electronic device, with the new electronic device running a second operating system and transmitting registration credentials to the new electronic device. And may also include determining whether any of the first apps have corresponding second apps available for the second operating system, queuing any corresponding apps for installation in the new electronic device, and initiating downloading and installation of the corresponding apps in the new electronic device.

In embodiments, an enterprise level application installation and catalog system may be provided for installing applications, which are installed on a first device of a first platform, onto a second device of a second platform. In embodiments, the application installation and catalog system may comprise a user profile catalog, a device registration subsystem, an application match subsystem, and an application provisioning and sync subsystem. Embodiments may also include a computer-implemented method for installing applications, which were installed on a first device of a first platform, onto a second device of a second platform. Embodiments may also include an enterprise level computer system for installing applications, which were installed on a first device of a first platform, onto a second device of a second platform the computer system.

Many variations of the invention beyond those explicitly described are possible. Moreover, modifications to the embodiments described herein are also possible. These modifications and variants may include various combinations of the embodiments described herein, various modifications to the embodiments described herein, use of portions of embodiments described herein, and still further teachings of the application in other environments and uses.

### BRIEF DESCRIPTION OF THE SEVERAL VIEWS OF THE DRAWINGS

FIG. 1 illustrates a block diagram of a networked environment as may be employed in various embodiments of the invention.

FIG. 2 illustrates a computer system usable with a cross-device and cross-platform application installation catalog system as may be employed in various embodiments of the invention.

FIG. 3 is a functional block diagram illustrating the cross-device and cross-platform application installation catalog system as may be employed in various embodiments of the invention.

FIG. 4 is a block diagram of a user profile catalog as may be employed in various embodiments of the invention.

FIG. 5 is a block diagram of an application match sub-system as may be employed in various embodiments of the invention.

FIG. 6 shows a process diagram of the operation of the application installation catalog system as may be carried out in one or more systems employing embodiments of the invention.

### DETAILED DESCRIPTION

Methods, devices, and manufactures are provided for installing applications, which were installed on a first device of a first platform, onto a second device of a second platform. In embodiments, seamless or automated support may be provided such that when a user changes devices or otherwise switches operating systems, migration between the operating systems may be managed and supported on an enterprise level, on a client level, or elsewhere. Embodiments may include the use of a cross-device or cross-platform enterprise application installation catalog. This profile catalog of installed applications may be maintained and used for matching with corresponding platform specific application before, during or after transfer between devices or platforms. The profile catalog may also be used for triggering an install through the possible use of device specific application store data as well as with application purchase histories. Other triggers may also be used in embodiments.

Embodiments may be employed with various Mobile Device Management (MDM) enterprise applications and may serve to support Bring Your Own Device (BYOD) policy. As mentioned in more detail below, enterprise applications may maintain a user profile catalog that can include or otherwise maintain or link to application history and access history. This personal profile catalog may be used to matching corresponding applications as one or more users change their device registrations and institute application provisioning. These adjustments and changes may be based on user or device catalog entries and user or device access histories.

Various features may be employed when carrying out embodiments. These features may include: a user profile catalog, which can maintain user device profiles, application lists and access logs; an application match sub system, which can maintain a cross platform; device OS application matching tables that can aid in application provisioning upon device change registration; a device registration subsystem, which can include device change and new device registration that interfaces with user profile catalogs and application match subsystem; and application provisioning and sync systems, which can aid in triggering the install (with device specific app store and purchase history) and update the user profile catalog with subsequent platform specific updates.

In embodiments, the application provisioning and synchronization system component may be employed to establish a framework that can promote multi-platform application mapping either by: name of the application, provider or dept., where the name can be searchable for possible match; application ID, where the application ID metadata may describe the application independent of the mobile OS, and may be unique to the vendor or a certain department; and mobile OS specific app ID, which may include an ID specific to a mobile OS and may be implemented while submitting an application to an app store.

In embodiments, upon a device change, where new registration is employed because of Mobile Device Management (“MDM”) or for obtaining a new Universally Unique Identifier (“UUID”) for ecosystem interaction (such as push notification, SMS, etc.) a device registration subsystem in embodiments can successfully register the device and assign the necessary device credentials; list the installed app by name and application ID; and find the corresponding mobile OS specific application ID mapped to application ID. When there is success, the subsystem may queue up the application for install on a new device and when the install is considered successful, updates of a user profile catalog having the mobile OS specific app ID and application ID may be performed. When there is not success, for example, in the event that the corresponding mobile OS specific application ID mapped to application ID is not found, the user profile may be updated with solely application ID and without mobile OS specific application ID for future updates or device changes.

In embodiments, if an application is not available on the target platform the unavailable application may not be transferred and installed but a catalog of the application may be updated such that should a user migrate back of to another platform that does accept this unavailable application the application may be transferred to this third platform or back to the original platform. Put another way, if application A runs on OS1 but not on OS2 application A will not be transferred to OS2 but a log can be updated to identify the presence of application A in OS1. This log may then be referenced during a subsequent migration such that application A may be transferred to OS3 or back to OS1.

Thus, in embodiments, a profile catalog of installed applications may be matched with the corresponding platform specific applications and subsequently used for triggering the migration of applications and other user configurations across devices and across platforms. This management and these changes may be completed at the client level and the enterprise level.

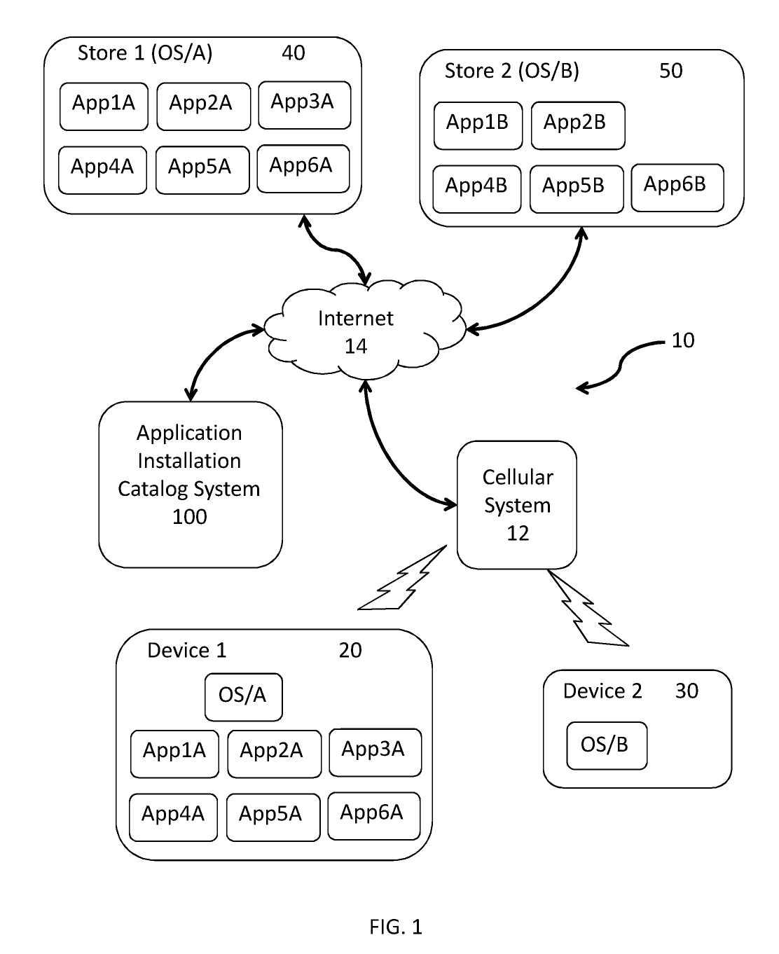

FIG. 1 is a functional block diagram of a networked environment 10 in accordance with various embodiments of the invention. Interconnections are shown among a cross-device and cross-platform application installation catalog system 100 with other components in the networked environment 10. Such components may include a first mobile device 20 operating under a first operating system OC/A and a second mobile device 30 operating under a second, different operating system OC/B. The first and second devices 20, 30 may be smartphones communicating with others through a cellular system 12 and able to transmit and receive data though the Internet 14. Also connected to the Internet 14 are two online application stores 40, 50 providing applications to electronic devices. As illustrated, one store 40 provides applications developed for devices, such as the first, current device 20, that operate with OS/A while the other store 50 provides applications developed for devices, such as the second, target device 30, that operate with OS/B. While the Figures and description refer to the electronic devices 20, 30 as being mobile devices, such as smartphones, the cross-device and cross-platform application installation catalog system 100 may be used to facilitate the installation of applications on other types of electronic devices, including notebook and desktop computers.

It will be appreciated that, although the Figures and description refer only to two devices 20 and 30 and two operating systems OS/A and OS/B, the system 100 may be used to manage the installation of applications on any number of new devices with a variety of operating systems.

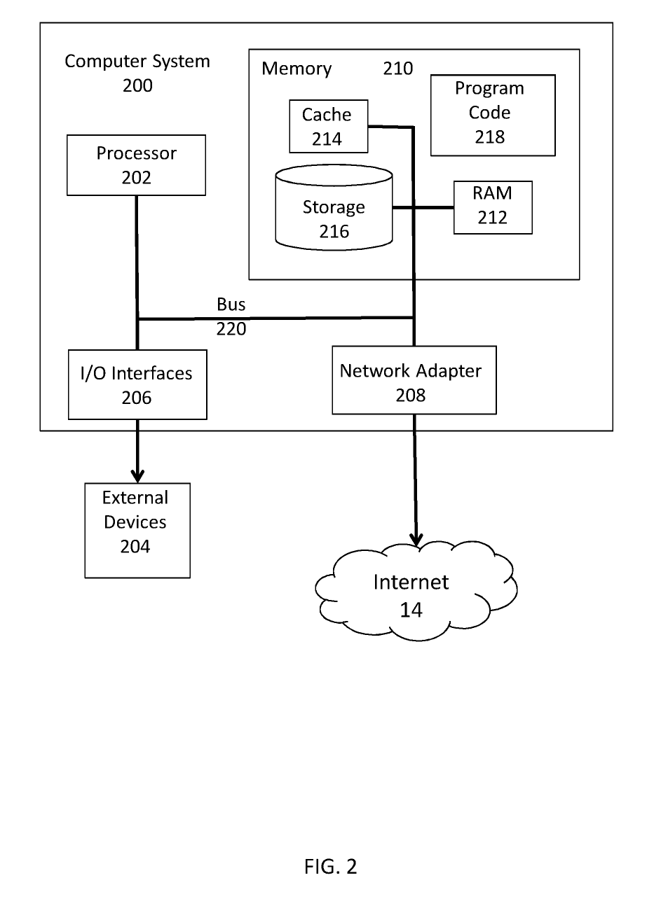

FIG. 2 illustrates a computer system 200 usable in the cross-device and cross-platform application installation catalog system 100 according to embodiments of the present invention. The computer system 200 is operationally coupled to a processor or processing units 202, a memory 210, and a bus 220 that couples various system components to the processor 202. The bus 220 represents one or more of any of several types of bus structure, including a memory bus or memory controller, a peripheral bus, an accelerated graphics port, and a processor or local bus using any of a variety of bus architectures. The memory 210 may include computer readable media in the form of volatile memory, such as random access memory (RAM) 212 or cache memory 214, or non-volatile storage media 216. The memory 210 may include at least one program product having a set of at least one program code module 218 that is configured to carry out the functions of embodiments of the present invention when executed by the processor 202. The computer system 200 may communicate with one or more external devices 204, such as a display, keyboard, etc., via I/O interfaces 206. The computer system 200 may also communicate with one or more networks, such as the Internet, via a network adapter 208.

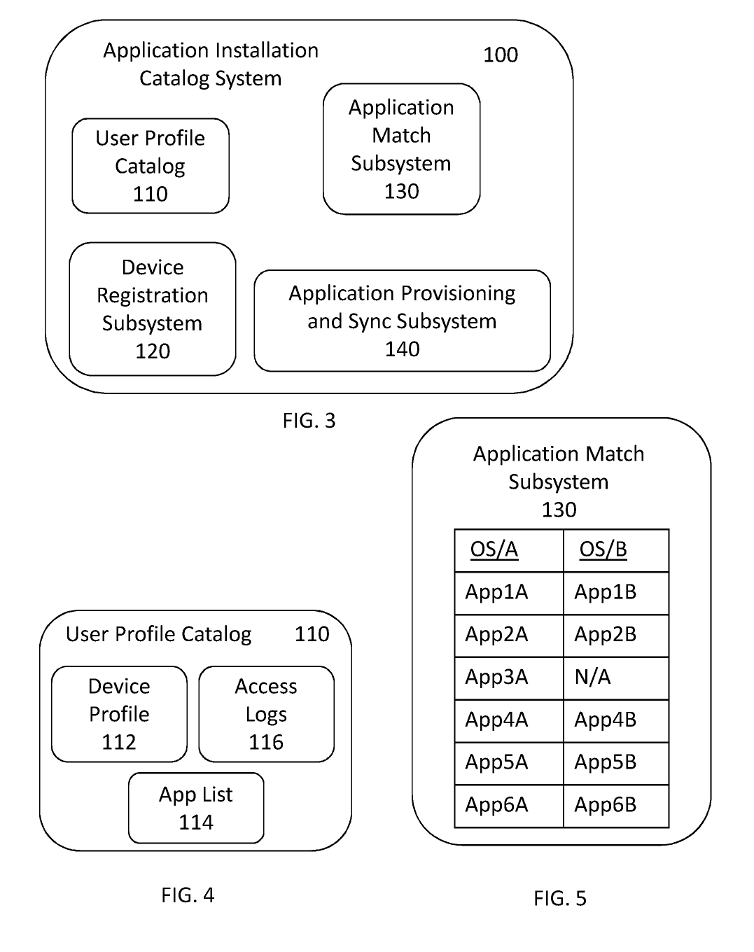

FIG. 3 is a functional block diagram illustrating the cross-device and cross-platform application installation catalog system 100 as may be employed in various embodiments of the invention. The system 100 may include a user profile catalog 110, a device registration subsystem 120, an application match subsystem 130, and an application provisioning and sync subsystem 140.

FIG. 4 is a block diagram of the user profile catalog 110. The catalog 110 may include modules, including a device profile 112, which maintains the profile of the current device 20, an app list 114, which maintains a list of the installed on the current device 20, and the access logs 116 for the current device 20. The applications may be identified and searchable by any or all of the following: the name of the application, the provider or developer, an application ID, metadata, and the operating system. In an enterprise environment in which the apps used by employees may vary by department, applications may also be identified by a department ID. Thus, apps may be categorized, sorted, and identified in a number of ways, facilitating the process of switching from current to new devices.

FIG. 5 is a block diagram of the application match subsystem 130, which may include a cross-platform, cross-device OS database. The application match subsystem 130 will be populated with entries for the OS/A apps installed on the current device 20 and any corresponding OS/B apps developed that are available for installation on the new, target device 30.

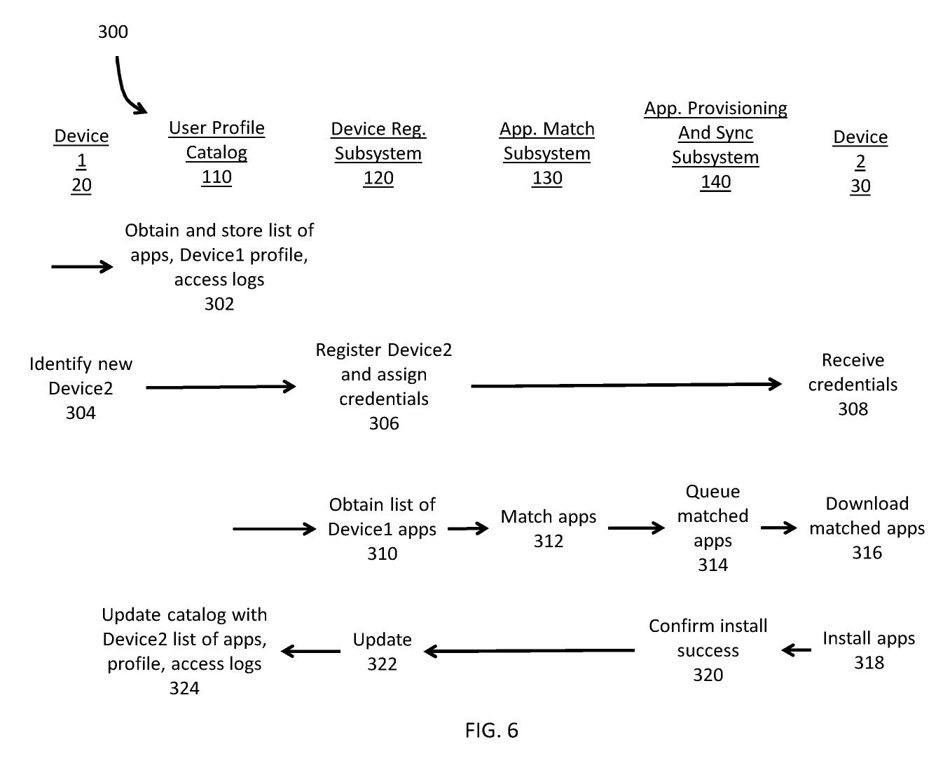

FIG. 6 illustrates a process 300 of the application installation catalog system 100 as may be carried out in one or more systems employing embodiments of the invention. Prior to the process 300 beginning, the user of the current device 20 will have installed various apps App1A-App6A on the device 20 from the first online store 40. When the user acquires the new, target device 30, he/she may want to install all of some of the same apps on the target device 30, apps that are provided, if available, from the second online store 50. The user initiates the process 300 by connecting the current device 20 with the system 100 via the appropriate network(s), such as the cellular network 12 and the Internet 14. In other environments, such as an enterprise environment with mobile device management supporting a “bring your own device” policy, the current device 20 may be connected with the system 100 through a wired or wireless network.

Once connected, the current device 20 sends information about the device 20 to the system 100 (step 302) where the information is stored in the device profile 112, app list 114, and access logs 116 modules of the user profile catalog 110. Alternatively, the device profile catalog may have been populated with information about the current device 20 when the user first acquired the device 20 and periodically afterwards when new apps were installed or other changes made. The user then connects the new device 30 with the system 100 and identifies it as a new device to be registered and provided with as many of the same apps as possible that are installed on the current device 20 (step 304). The device registration subsystem 130 registers the new device (step 306) and sends new credentials to the new device 30 (step 308). Such credentials may include a new universally unique identifier (UUID), useful for pushing notifications to the new device 30 and for SMS messaging.

The device registration subsystem 130 also obtains from the app list 114 in the user profile catalog 110 the list of apps installed on the current device 20 (step 310). The list is sent to the application match subsystem 120, which attempts to identify OS/B apps that correspond with the OS/A apps on the app list (step 312). The application match subsystem 120 may access match information that it obtained and stored during previous match attempts for other devices or may access the second app store 50 to identify matching OS/B apps. In the Figures, matches were only found for App1A, App2A, and App4A-App 6A. A match for App3A was not found; therefore, the corresponding entry is “not available” (N/A) or another suitable indication.

Once matching apps have been identified, they are queued up in the application provisioning and sync subsystem 140. Using purchase history, such as from the user or the enterprise, the application provisioning and sync subsystem 140 authorizes and initiates the download of the matched apps to the new device 30 (step 316). The apps are installed (step 318) in the new device 30 which confirms for the application provisioning and sync subsystem 140 that each app was successfully installed (step 320).

Based on the confirmations, the application provisioning and sync subsystem 140 may send update information to the device registration subsystem 130 (step 322) which forwards the information to the user profile catalog 110 (step 324). The device profile 112 and access logs 116 are updated with information about the new device 30. The app list is also updated to note which apps from the current (now old) device 20 were installed on the new device 30 (App1B, App2B, and App4B-App 6B) and which were not (App3B). In this way, a search for the apps not installed may be conducted periodically to determine if they become available or when the user changes to a different device or platform in the future. The device registration subsystem may also be updated with other device-related information, such as the time and date of the latest sync for each device.

The system 100 and process 300 provide a cross-device, cross-platform environment for changing electronic devices that is substantially automatic. The system 100 and process 300 alleviate much of the conventional manual process when a new device is acquired of having to remember each app to be installed and their settings, then downloading and installing the apps that are available for the new operating system.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instruction for executing a computer process.

The present invention may be a system, a method, and/or a computer program product. The computer program product may include a computer readable storage medium (or media) having computer readable program instructions thereon for causing a processor to carry out aspects of the present invention.

The computer readable storage medium is a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

What is claimed is:

1. A computer program product for installing applications, which were installed on a first device of a first platform, onto a second device of a second platform, the computer program product comprising a computer readable storage medium having program instructions embodied therewith, the program instructions readable by a circuit to cause the circuit to perform a method comprising:
obtaining and storing a list of first apps installed on a current electronic device, a profile of the current electronic device, and access logs for the current electronic device, the current electronic device running a first operating system;
receiving an identification of a new electronic device and request for registration of the new electronic device, the new electronic device running a second operating system;
transmitting registration credentials to the new electronic device;
determining whether any of the first apps have corresponding second apps available for the second operating system;
queuing any corresponding apps for installation in the new electronic device; and
at the new electronic device or an enterprise level component, initiating downloading and installation of the corresponding apps in the new electronic device.

2. The computer program product of claim 1, further comprising, after the corresponding apps have been installed in the new electronic device:
receiving confirmation that the corresponding apps were successfully installed in the new electronic device;
updating a device registration subsystem with information about the corresponding apps; and
updating a user profile catalog with a list of the corresponding apps, and a profile of the new electronic device.

3. The computer program product of claim 1, wherein obtaining and storing the list of first apps and the profile of the current electronic device is performed in a user profile catalog.

4. The computer program product of claim 1, wherein receiving the identification of a new electronic device and request for registration of the new electronic device is performed in a device registration subsystem.

5. The computer program product of claim 1, wherein determining whether any of the first apps have corresponding second apps available for the second operating system is performed in an application match subsystem.

6. The computer program product of claim 1, wherein queuing any corresponding apps for installation in the new electronic device is performed in an application provisioning and sync subsystem.

7. A computer-implemented method for installing applications, which were installed on a first device of a first platform, onto a second device of a second platform, the computer-implemented method comprising:
obtaining and storing a list of first apps installed on a current electronic device, a profile of the current electronic device, and access logs for the current electronic device, the current electronic device running a first operating system;
receiving an identification of a new electronic device and request for registration of the new electronic device, the new electronic device running a second operating system;
transmitting registration credentials to the new electronic device;
determining whether any of the first apps have corresponding second apps available for the second operating system;
queuing any corresponding apps for installation in the new electronic device; and
at the new electronic device or an enterprise level component, initiating downloading and installation of the corresponding apps in the new electronic device.

8. The computer-implemented method of claim 7, further comprising, after the corresponding apps have been installed in the new electronic device:
receiving confirmation that the corresponding apps were successfully installed in the new electronic device;
updating a device registration subsystem with information about the corresponding apps; and
updating a user profile catalog with a list of the corresponding apps and a profile of the new electronic device.

9. The computer-implemented method of claim 7, wherein obtaining and storing the list of first apps and the profile of the current electronic device is performed in a user profile catalog.

10. The computer-implemented method of claim 7, wherein receiving the identification of a new electronic device and request for registration of the new electronic device is performed in a device registration subsystem.

11. The computer-implemented method of claim 7, wherein determining whether any of the first apps have corresponding second apps available for the second operating system is performed in an application match subsystem.

12. The computer-implemented method of claim 7, wherein queuing any corresponding apps for installation in the new electronic device is performed in an application provisioning and sync subsystem.

13. A computer system for installing applications, which were installed on a first device of a first platform, onto a second device of a second platform the computer system, comprising:
one or more processors; and
one or more computer readable storage medium having program instructions embodied therewith for execution by the one or more processors, the program instructions readable by a circuit to cause the system to perform a method comprising:
in an enterprise level component, obtaining and storing a list of first apps installed on a current electronic device and a profile of the current electronic device, the current electronic device running a first operating system;
in an enterprise level component, receiving an identification of a new electronic device and request for registration of the new electronic device, the new electronic device running a second operating system;
in an enterprise level component, transmitting registration credentials to the new electronic device;
in an enterprise level component, determining whether any of the first apps have corresponding second apps available for the second operating system;
in an enterprise level component, queuing any corresponding apps for installation in the new electronic device; and
at the new electronic device or an enterprise level component, initiating downloading and installation of the corresponding apps in the new electronic device.

14. The computer system of claim 13, the method further comprising, after the corresponding apps have been installed in the new electronic device:
in an enterprise level component, receiving confirmation that the corresponding apps were successfully installed in the new electronic device;
in an enterprise level component, updating a device registration subsystem with information about the corresponding apps; and
in an enterprise level component, updating a user profile catalog with a list of the corresponding apps and a profile of the new electronic device.

15. The computer system of claim 13, the method further comprising, in an enterprise level component, obtaining and storing the list of first apps and the profile of the current electronic device in a user profile catalog.

16. The computer system of claim 13, the method further comprising, in an enterprise level component, receiving the identification of a new electronic device and request for registration of the new electronic device in a device registration subsystem.

17. The computer system of claim 13, the method further comprising, in an enterprise level component, determining whether any of the first apps have corresponding second apps available for the second operating system in an application match subsystem.

18. The computer system of claim 13, the method further comprising in an enterprise level component, queuing any corresponding apps for installation in the new electronic device in an application provisioning and sync subsystem.
